(19) United States
(12) Patent Application Publication
(10) Pub. No.: US 2014/0278403 A1
(43) Pub. Date: Sep. 18, 2014

(54) SYSTEMS AND METHODS FOR INTERACTIVE SYNTHETIC CHARACTER DIALOGUE

(71) Applicant: TOYTALK, INC., San Francisco, CA (US)

(72) Inventors: Oren M. Jacob, Piedmont, CA (US); Martin Reddy, San Francisco, CA (US); Lucas R.A. Ives, Menlo Park, CA (US); Robert G. Podesta, Oakland, CA (US)

(73) Assignee: TOYTALK, INC., San Francisco, CA (US)

(21) Appl. No.: 13/829,925

(22) Filed: Mar. 14, 2013

(51) Int. Cl. G10L 21/10; G10L 15/26

(52) U.S. Cl. CPC G10L 21/10; G10L 15/26
USPC 704/235; 704/272

(57) ABSTRACT

Various of the disclosed embodiments concern systems and methods for conversation-based human-computer interactions. In some embodiments, the system includes a plurality of interactive scenes. A user may access each scene and engage in conversation with a synthetic character regarding an activity associated with that active scene. In certain embodiments, a central server may house a plurality of waveforms associated with the synthetic character's speech, and may dynamically deliver the waveforms to a user device in conjunction with the operation of an artificial intelligence. In other embodiments, the character's speech is generated using a text-to-speech system.

### FIELD OF THE INVENTION

Various of the disclosed embodiments concern systems and methods for conversation-based human-computer interactions.

### BACKGROUND

Human computer interaction (HCl) involves the interaction between humans and computers, focusing on the intersection of computer science, cognitive science, interface design, and many other fields. Artificial intelligence (Al) is another developing discipline which includes adaptive behaviors allowing computer systems to respond organically to a user's input. While Al may be used to augment HCl, possibly by providing a synthetic character for interacting with the user, the interaction may seem stale and artificial to the user if the Al is unconvincing. This is particularly true where the Al fails to account for contextual factors regarding the interaction and where the Al fails to maintain a “life-like” persona when interacting with the user. Conversation, though an excellent method for human-human interaction, may be especially problematic for an Al system because of conversation's contextual and inherently ambiguous character. Even children, who may more readily embrace inanimate characters as animate entities, can recognize when a conversational Al has become disassociated from the HCl context. Teaching and engaging children through Has would be highly desirable, but must overcome the obstacle of lifeless and contextually ignorant Al behaviors.

Accordingly, there exists a need for systems and methods to provide effective HCl interactions to users, particularly younger users, that accommodate the challenges of conversational dialogue.

### SUMMARY

Certain embodiments contemplate a method for engaging a user in conversation with a synthetic character, the method comprising: receiving an audio input from a user, the audio input comprising speech; acquiring a textual description of the speech; determining a responsive audio output based upon the textual description; and causing a synthetic character to speak using the determined responsive audio output.

In some embodiments, the method further comprises receiving a plurality of audio inputs comprising speech from a user, the plurality of audio inputs associated with a plurality of spoken outputs from one or more synthetic characters. In some embodiments, the plurality of audio inputs comprise answers to questions posed by one or more synthetic characters. In some embodiments, the plurality of audio inputs comprise a narration of text and the plurality of spoken outputs from one or more synthetic characters comprise ad-libbing or commentary to the narration. In some embodiments, the plurality of audio inputs comprise statements in a dialogue regarding a topic. In some embodiments, acquiring a textual description of the speech comprises transmitting the audio input to a dedicated speech processing service. In some embodiments, receiving an audio input comprises determining whether to perform one of “Automatic-Voice-Activity-Detection”, “Hold-to-Talk”, “Tap-to-Talk”, or “Tap-to-Talk-With-Silence-Detection” operations. In some embodiments, the method further comprises modifying an icon to reflect the determined audio input operation. In some embodiments, the method further comprises modifying an icon to reflect the determined audio input operation. In some embodiments, determining a responsive audio output comprises determining user personalization metadata. In some embodiments, the method further comprises acquiring phoneme animation metadata associated with the responsive audio output for the purpose of animating some of the character's facial features. In some embodiments, the method further comprises modifying an icon to reflect the determined audio input operation. reviewing a plurality of responses from the user and performing more inter-character dialogue rather than user-character dialogue based on the review. In some embodiments, the method further comprises associating prioritization metadata with each potential response for the synthetic character and using these prioritization metadata to cause one possible response to be output before other responses. In some embodiments, causing a synthetic character to speak using the determined responsive audio output comprises causing the synthetic character to propose taking a picture using a user device. In some embodiments, the method further comprises: causing a picture to be taken of a user, using a user device; and sending the picture to one or more users of a social network.

Certain embodiments contemplate a method for visually engaging a user in conversation with a synthetic character comprising: retrieving a plurality of components associated with an interactive scene, the interactive scene selected by a user; configuring at least one of the plurality of components to represent a synthetic character in the scene; and transmitting at least some of the plurality of components to a user device.

In some embodiments, the method further comprises retrieving personalization metadata associated with a user and modifying at least one of the plurality of components based on the personalization metadata. In some embodiments, retrieving a plurality of components comprises retrieving a plurality of speech waveforms from a database.

Certain embodiments contemplate a computer system for engaging a user in conversation with a synthetic character, the system comprising: a display; a processor; a communication port; a memory containing instructions, wherein the instructions are configured to cause the processor to: receive an audio input from a user, the audio input comprising speech; acquire a textual description of the speech; determine a responsive audio output based upon the textual description; and cause a synthetic character to speak using the determined responsive audio output.

In some embodiments receiving an audio input comprises determining whether to perform one of “Automatic-Voice-Activity-Detection”, “Hold-to-Talk”, “Tap-to-Talk”, or “Tap-to-Talk-With-Silence-Detection” operations. In some embodiments, the instructions are further configured to cause the processor to modify an icon to reflect the determined operation. In some embodiments, to determine a responsive audio output comprises determining user personalization metadata. In some embodiments, the instructions are further configured to cause the processor to acquire phoneme metadata associated with the responsive audio output for the purpose of animating some of the character's facial features. In some embodiments, the instructions are further configured to cause the processor to review a plurality of responses from the user and perform more inter-character dialogue rather than user-character dialogue based on the review. In some embodiments, the instructions are further configured to cause the processor to associate prioritization metadata with each potential response for the synthetic character and use these prioritization metadata to cause one possible response to be output before other responses. In some embodiments, causing a synthetic character to speak using the determined responsive audio output comprises causing the synthetic character to propose taking a picture using a user device.

Certain embodiments contemplate a computer system for engaging a user in conversation with a synthetic character, the computer system comprising: means for receiving an audio input from a user, the audio input comprising speech; means for determining a description of the speech; means for determining a responsive audio output based upon the description; and means for causing a synthetic character to speak using the determined responsive audio output.

In some embodiments, the audio input receiving means comprises one of a microphone, a packet reception module, a WiFi receiver, a cellular network receiver, an Ethernet connection, a radio receiver, a local area connection, or an interface to a transportable memory storage device. In some embodiments, the speech description determining means comprises one of a connection to a dedicated speech processing server, a natural language processing program, a speech recognition system, a Hidden Markov Model, or a Bayesian Classifier. In some embodiments, the responsive audio output determination means comprises one of an Artificial Intelligence engine, a Machine Learning classifier, a decision tree, a state transition diagram, a Markov Model, or a Bayesian Classifier. In some embodiments, the synthetic character speech means comprises one of a speaker, a connection to a speaker on a mobile device, a WiFi transmitter in communication with a user device, a packet transmission module, a cellular network transmitter in communication with a user device, an Ethernet connection in communication with a user device, a radio transmitter in communication with a user device, or a local area connection in communication with a user device.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates a block diagram of various components in a system as may be implemented in certain embodiments.

FIG. 2 illustrates a topological relationship between a plurality of interactive scenes in a virtual environment as may be used in certain embodiments.

FIG. 3 illustrates an example screenshot of a graphical user interface (GUI) of a main scene in a virtual environment as may be implemented in certain embodiments.

FIG. 4 illustrates an example screenshot of a “fireside chat scene” GUI in a virtual environment as may be implemented in certain embodiments.

FIG. 5 illustrates an example screenshot of a “versus scene” GUI in a virtual environment as may be implemented in certain embodiments.

FIG. 6 illustrates an example screenshot of a “game show scene” GUI in a virtual environment as may be implemented in certain embodiments.

FIG. 7 illustrates an example screenshot of a “story telling scene” GUI in a virtual environment as may be implemented in certain embodiments.

FIG. 8 is a flowchart depicting certain steps in a user interaction process with the virtual environment as may be implemented in certain embodiments.

FIG. 9 is a flowchart depicting certain steps in a component-based content management and delivery process as may be implemented in certain embodiments.

FIG. 10 illustrates an example screenshot of a GUI for a component creation and management system as may be implemented in certain embodiments.

FIG. 11 is a flowchart depicting certain steps in a dynamic Al conversation management process as may be implemented in certain embodiments.

FIG. 12 is a flowchart depicting certain steps in a frustration management process as may be implemented in certain embodiments.

FIG. 13 is a flowchart depicting certain steps in a speech reception process as may be implemented in certain embodiments.

FIG. 14 illustrates an example screenshot of a social asset sharing GUI as may be implemented in certain embodiments

FIG. 15 illustrates an example screenshot of message drafting tool in the social asset sharing GUI of FIG. 14 as may be implemented in certain embodiments.

FIG. 16 is a flowchart depicting certain steps in a social image capture process as may be implemented in certain embodiments.

FIG. 17 is a block diagram of components in a computer system which may be used to implement certain of the disclosed embodiments.

### DETAILED DESCRIPTION

The following description and drawings are illustrative and are not to be construed as limiting. Numerous specific details are described to provide a thorough understanding of the disclosure. However, in certain instances, well-known details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Overview

Certain of the disclosed embodiments concern systems and methods for conversation-based human-computer interactions. In some embodiments, the system includes a plurality of interactive scenes in a virtual environment. A user may access each scene and engage in conversation with a synthetic character regarding an activity associated with that active scene. In certain embodiments, a central server may house a plurality of waveforms associated with the synthetic character's speech, and may dynamically deliver the waveforms to a user device in conjunction with the operation of an artificial intelligence. In some embodiments, speech is generated with text-to-speech utilities when the waveform from the server is unavailable or inefficient to retrieve.

FIG. 1 illustrates a block diagram of various components in a system as may be implemented in certain embodiments. In some embodiments, a host server system 101 may perform various of the disclosed features and may be in communications with a user devices 110a-b via networks 108a-b. In some embodiments, networks 108a-b are the same network and may be any commonly known network, such as the Internet, a Local Area Network (LAN), a local WiFi ad-hoc network, etc. In some embodiments, the networks include transmissions from cellular towers 107a-b and the user devices 110a-b. Users 112a-b may interact with a local application on their respective devices using a user interface 109a-b. In some embodiments, the user may be in communication with server 101 via the local application. The local application may be a stand-alone software program, or may present information from server 101 with minimal specialized local processing, for example, as an internet browser.

The server 101 may include a plurality of software, firmware, and/or hardware modules to implement various of the disclosed processes. For example, the server may include a plurality of system tools 102, such as dynamic libraries, to perform various functions. A database to store metadata 103 may be included as well as databases for storing speech data 104 and animation data 105. In some embodiments, the server 101, may also include a cache 106 to facilitate more efficient response times to asset requests from user devices 110a-b.

In certain embodiments, server 101 may host a service that provides assets to user devices 110a-b so that the devices may generate synthetic characters for interaction with a user in a virtual environment. The operation of the virtual environment may be distributed between the user devices 110a-b and the server 101 in some embodiments. For example, in some embodiments the virtual environment and/or Al logic may be run on the server 101 and the user devices may request only enough information to display the results. In other embodiments, the virtual environment and/or Al may run predominately on the user devices 110a-b and communicate with the server only aperiodically to acquire new assets.

### Virtual Environment Topology

FIG. 2 illustrates a topological relationship between a plurality of interactive scenes in a virtual environment as may be used in certain embodiments. In this example, there are three interactive scenes A, B, C, 201a-c and a Main Scene 201d from which a user may begin an interactive session. In some embodiments, the scenes may comprise “rooms” in a house, or different “games” in a game show. Each interactive scene may present a unique context and may contain some elements common to the other scenes and some elements which are unique. A user may transition from some scenes without restriction, as in the case of transitions 202c-e. Some transitions, however, may be unidirectional, such as the transition 202b from scene A 201a to scene B 201b and the transition 202a from scene C 201c to scene A 201a. In some embodiments the user transitions between scenes by oral commands or orally indicated agreement with synthetic character propositions.

In some embodiments, the user may be required to return to the main scene 201d following an interaction, so that the conversation Al logic may be reinitialized and configured for a new scene.

### Example Virtual Environment Scenes

FIG. 3 illustrates an example screenshot of a graphical user interface (GUI) 300 of a main scene in a virtual environment as may be implemented in certain embodiments. In some embodiments, the GUI may appear on an interface 109a-b, such as on a display screen of a mobile phone, or on a touch screen of a mobile phone or of a tablet device. As illustrated in this example, the GUI 300 may include a first 301a and second 301b depiction of a synthetic character, a menu bar 302 having a user graphic 304a, a separate static or real-time user video 304b, and a speech interface 303.

Menu 302 may depict common elements across all the scenes of the virtual environment, to provide visual and functional continuity to the user. Speech interface 303 may be used to respond to inquiries from synthetic characters 301a-b. For example, in some embodiments the user may touch the interface 303 to activate a microphone to receive their response. In other embodiments the interface 303 may illuminate or otherwise indicate an active state when the user selects some other input device. In some embodiments, the interface 303 may illuminate automatically when recording is initiated by the system.

In some embodiments, real-time user video 304b depicts a real-time, or near real-time, image of a user as they use a user device, possibly acquired using a camera in communication with the user device. As indicated in FIG. 3, the depiction of the user may be modified by the system, for example, by overlaying facial hair, wigs, hats, earrings, etc. onto the real-time video image. The overlay may be generated in response to the activities occurring in the virtual environment and/or by conversation with the synthetic characters. For example, where the interaction involves role-playing, such as including the user in a pirate adventure, the user's image may be overlaid with a pirate hat, skull and bones, or similar asset germane to the interaction. In some embodiments, user graphic 304a is a static image of the user. During application setup, the system may take an image of the user and archive the image as a “standard” or “default” image to be presented as user graphic 304a. However, as described in greater detail herein, in some embodiments the user may elect to have their image with an overlaid graphic replace the user graphic 304a. In some embodiments, the user may replace user graphic 304a at their own initiative.

In some embodiments, the interaction may include a suggestion or an invitation by one or more of the synthetic characters for the user to activate the taking of their picture by the user device, or for the system to automatically take the user's picture. For example, upon initiating the piracy interaction and after first presenting the user with the pirate hat, a synthetic character may comment on the user's appearance and offer to capture the user's image using a camera located on the user device. If the user responds in the affirmative, the system may then capture the image and archive the image or use the image to replace user graphic 304a, either permanently or for some portion of the piracy interaction. In some embodiments, the same or corresponding graphics may be overlaid upon the synthetic characters' images.

As described in greater detail herein, synthetic characters 301a-b may perform a variety of animations, both to indicate that they are speaking as well as to interact with other elements of the scene.

FIG. 4 illustrates an example screenshot of a “fireside chat scene” GUI 400 in a virtual environment as may be implemented in certain embodiments. Elements in the background 403 may indicate to the user which scene the user is currently in. In this example, an image of the user 401, possibly a real-time image acquired using a camera on the user's device, may be used. A synthetic character, such as synthetic character 301b, may pose questions to the user throughout an interaction and the user may respond using speech interface 303. A text box 402 may be used to indicate the topic and nature of the conversation (e.g., “school”).

FIG. 5 illustrates an example screenshot of a “versus scene” GUI 500 in a virtual environment as may be implemented in certain embodiments. In this example, even though a synthetic character is not visible in the GUI 500, the system may still pose questions (possibly with the voice of a synthetic character) and receive responses and statements from the user. In this scene, a scrolling header 504a may be used to indicate contextual information relevant to the conversation. In this example, the user, depicted in element 501, is engaged in a battle of wits with a pirate, depicted in opponent image 503. Text boxes 502a-b may be used to indicate questions posed by the system and possible answer responses that may be given, or are expected to be given, by the user.

FIG. 6 illustrates an example screenshot of a “game show scene”GUI in a virtual environment as may be implemented in certain embodiments. In this scene, synthetic character 301b may conduct a game show wherein the user is a contestant. The synthetic character 301b may pose questions to the user. Expected answers may be presented in text boxes 602a-c. A synthetic character 301c may be a different synthetic character from character 301b or may be a separately animated instantiation of the same character. Synthetic character 301c may be used to pose questions to the user. A title screen 603 may be used to indicate the nature of the contest. The user's image may be displayed in real-time or near real-time in region 601.

FIG. 7 illustrates an example screenshot of a “story telling scene” GUI 700 in a virtual environment as may be implemented in certain embodiments. In this scene, the GUI 700 may be divided into a text region 701 and a graphic region 702. The synthetic characters 301a-b may narrate and/or role-play portions of a story as each region 701, 702 is updated. The characters 301a-b may engage in dialogue with one another and may periodically converse with the user, possibly as part of a role-playing process wherein the user assumes a role in the story. In some embodiments, the user reads the text in region 701, and the characters 301a-b ad-lib or comment upon portions of the story or upon the user's reading.

### User Interaction

FIG. 8 is a flowchart depicting certain steps in a user interaction process with the virtual environment as may be implemented in certain embodiments. At step 801 the system may present the user with a main scene, such as an scene depicted in FIG. 3. At step 802, the system may receive a user selection for an interactive scene (such as an oral selection). In some instances, the input may comprise a touch or swipe action relative to a graphical icon, but in other instances the input may be an oral response by the user, such as a response to an inquiry from a synthetic character. At step 803, the system may present the user with the selected interactive scene.

At step 804, the system may engage the user in a dialogue sequence based on criteria. The criteria may include previous conversations with the user and a database of statistics generated based on social information or past interactions with the user. At step 805, the system may determine whether the user wishes to repeat an activity associated with the selected scene. For example, a synthetic character may inquire as to the user's preferences. If the user elects, perhaps orally or via tactile input, to pursue the same activity, the system may repeat the activity using the same criteria as previously, or at step 806 may modify the criteria to reflect the previous conversation history.

Alternatively, if the user does not wish to repeat the activity the system can determine whether the user wishes to quit at step 807, again possibly via interaction with a synthetic character. If the user does not wish to quit the system an again determine which interactive scene the user wishes to enter at step 802. Before or after entering the main scene at step 802 the system may also modify criteria based on previous conversations and the user's personal characteristics. In some embodiments, the user transitions between scenes using a map interface.

In some embodiments, content can be tagged so that it will only be used when certain criteria are met. This may allow the system to serve content that is customized for the user. Example fields for criteria may include the following: Repeat—an alternative response to use when the character is repeating something; Once Only—use this response only one time, e.g., never repeat it; Age—use the response only if the user's age falls within a specified range; Gender—use the response only if the user's gender is male or female; Day—use the response only if the current day matches the specified day; Time —use the response only if the current time falls within the time range; Last Activity—use the response if the previous activity matches a specific activity; Minutes Played—use a response if the user has exceeded the given number of minutes of play; Region—use the response if the user is located in a given geographic region; Last Played—use the response if the user has not used the service for a given number of days; etc. Responses used by synthetic characters can be timestamped and recorded by the system so that the Al engine will avoid giving repetitive responses in the future. Users may be associated with user accounts to facilitate storage of their personal information.

Criteria may also be derived from analytics. In some embodiments, the system logs statistics for all major events that occur during a dialogue session. These statistics may be logged to the server and can be aggregated to provide analytics for how users interact with the service at scale. This can be used to drive updates to the content or changes to the priorities of content. For example, analytics can tell that users prefer one activity over another, allowing more engaging content to be surfaced more quickly for future users. In some embodiments, this re-prioritizing of content can happen automatically based upon data logged from users at scale.

Additionally, through analysis of past conversations, the writing team can gain insights into topics that require more writing because they occur frequently. Naturally, some content may play out to be funnier than other content. The system may want to use the “best” content early on in order to grab the user's interest and attention. The Al, or the designers, may accordingly tag content with High, Medium, or Low priorities. The Al engine may prefer to deliver content that is marked with higher priority than other content in some embodiments.

### Component Management

FIG. 9 is a flowchart depicting certain steps in a component-based content management and delivery process 900 as may be implemented in certain embodiments. In each of the example scenes of FIGS. 3-7 a variety of elements such as the text boxes 305, 402, 502a-b, 602a-c, title screen 603, user images 401, 501, 601 and synthetic characters 301a-c, may be treated by the system as “components”. A component may refer to an asset, or a collection of assets, that may appear, or be used, in an scene. For example components may include: An Image—an image layer with possible alpha transparency; A User Video Feed—displays the output of the device's camera, in some embodiments with face tracking to keep the camera trained on the user; Character Animation—displays an animated virtual character using either 3D geometry or 2D images; A Text Viewer—displays status text or an overview of the last question from the virtual character; Progressive Text Reveal—used to reveal words as the virtual character speaks them; Image-based Animation —display image-based affine animations such as flashing lights, moving pictures, or transitions between components; etc.

Upon, or before, entering an scene the system may determine which components are relevant to the interactive experience. Server 101 may then provide the user device 110a-b with the components, or a portion of the predicted components, to be cached locally for use during the interaction. Where the Al engine operates on server 101 the server 101 may determine which components to send to the user device 110a-b. In embodiments where the Al engine operates on the user device 110a-b, the user device may determine which components to request from the server. In each instance, in some embodiments the Al engine will only have components transmitted which are not already locally cached on the user device 110a-b.

With reference to the process 900, at step 901 the system may retrieve user characteristics, possibly from a database in communication with server 101 or a user device. At step 902 the system may retrieve components associated with the interactive scene. At step 903 the system may determine component personalization metadata. For example, the system may determine behavioral and conversational parameters of the synthetic characters, or may determine the images to be associated with certain components, possibly using criteria as described above.

At step 905 the system may initiate an interactive session 905. During the interactive session, at step 906 the system may log interaction statistics. During the interactive session at step 907, or following the interactive session's conclusion 908, at step 909, the system can report the interaction statistics.

FIG. 10 illustrates an example screenshot of a GUI 1000 for a component creation and management system as may be implemented in certain embodiments. In this example interface, a designer may create a list of categories 1002, some of which may be common to a plurality of scenes, while others, such as “fireside chats” 1004 are unique to a particular scene. Within each category, a designer may specify components 1003 and conversation elements 1005, as well as the interaction between the two. In some embodiments, the designer may indicate relations between the conversation elements and the components and may indicate what preferential order components should be selected, transmitted, prioritized, and interacted with. Various tools 1001 may be used to edit and design the conversation and component interactions, which may have elements common to a text editing or word processing software (e.g., spell checking, text formatting, etc.). Using GUI 1000 a designer may direction conversation interactions via component selection. For example, by specifying components for the answers 602a-c the system can increase the probability that a user will respond with one of these words.

### Asset Anticipation

FIG. 11 is a flowchart depicting certain steps in a dynamic Al conversation management process as may be implemented in certain embodiments. At step 1101, the system can predict possible conversation paths that may occur between a user and one or more synthetic characters, or between the synthetic characters where their conversations are nondeterministic. At step 1102, the system may retrieve N speech waveforms from a database and cache them either locally at server system 101 or at user device 110a-b. At step 1103, the system can retrieve metadata corresponding to the N speech waveforms from a database and cache them either locally at server system 101 or at user device 110a-b. At step 1104, the system may notify an Al engine of the speech waveforms and animation metadata cached locally and may animate synthetic characters using the animation metadata. In this manner, the Al engine may anticipate network latency and/or resource availability in the selection of content to be provided to a user.

In some embodiments the animation may be driven by phoneme metadata associated with the waveform. For example, timestamps may be used to correlate certain animations, such as jaw and lip movements, with the corresponding points of the waveform. In this manner, the synthetic character's animations may dynamically adapt to the waveforms selected by the system. In some embodiments, this “phoneme metadata” may comprise offsets to be blended with the existing synthetic character animations. The phoneme metadata may be automatically created during the asset creation process or it may be explicitly generated by an animator or audio engineer. Where the waveforms are generated by a text-to-speech program, the system may concatenate elements form a suite of phoneme animation metadata to produce the phoneme animation metadata associated with the generated waveform.

### Frustration Management

FIG. 12 is a flowchart depicting certain steps in a frustration management process as may be implemented in certain embodiments. At step 1201 the system monitors a conversation log. In some embodiments the system may monitor a preexisting record of conversations. In some embodiments the system may monitor an ongoing log of a current conversation. As part of the monitoring, the system may identify responses from a user as indicative of frustration and may tag the response accordingly.

At step 1202, the system may determine if frustration tagged responses exceed a threshold or if the responses otherwise meet a criteria for assessing the user's frustration level. Where the user's responses indicate frustration, the system may proceed to step 1203, and notify the Al Engine regarding the user's frustration. In response, at step 1204, the Al engine may adjust the interaction parameters between the synthetic characters to help alleviate the frustration. For example, rather than engage the user as often in responses, the characters may be more likely to interact with one another or to automatically direct the flow of the interaction to a situation determined to be more conducive to engaging the user.

### Speech Reception

FIG. 13 is a flowchart depicting certain steps in a speech reception process 1300 as may be implemented in certain embodiments. At step 1301, the system may determine a character of an expected response by the user. In some embodiments, the character of the response may be determined based on the immediately preceding statements and inquiries of the synthetic characters.

At step 1302, the system can determine if “Hold-to-Talk” functionality is suitable. If so, the system may present a “Hold-to-Talk” icon at step 1305, and perform a “Hold-to-Talk” operation at step 1306. The “Hold-to-Talk” icon may appear as a modification of, or icon in proximity to, speech interface 303. In some embodiments, no icon is present (e.g., step 1305 is skipped) and the system performs “Hold-to-Talk” operation at step 1306 using the existing icon(s). The “Hold-to-Talk” operation may include a process whereby recording at the user device's microphone is disabled when the synthetic characters are initially waiting for a response. Upon selecting an icon, such as speech interface 303, recording at the user device's microphone may be enabled and the user may respond to the conversation involving the synthetic characters. The user may continue to hold (e.g. physically touching or otherwise providing tactile input) the icon until they are done providing their response and may then release the icon to complete the recording.

At step 1303, the system can determine if “Tap-to-Talk” functionality is suitable. If so, the system may present a “Tap-to-Talk” icon at step 1307, and perform a “Tap-to-Talk” operation at step 1308. The “Tap-to-Talk” icon may appear as a modification of, or icon in proximity to, speech interface 303. In some embodiments, no icon is present (e.g., step 1307 is skipped) and the system performs “Tap-to-Talk” operation at step 1308 using the existing icon(s). The “Tap-to-Talk” operation may include a process whereby recording at the user device's microphone is disabled when the synthetic characters initially wait for a response. Upon selecting an icon, such as speech interface 303, recording at the user device's microphone may be enabled and the user may respond to the conversation involving the synthetic characters. Following completion of their response, the user may again select the icon, perhaps the same icon as initially selected, to complete the recording and, in some embodiments, to disable the microphone.

At step 1304, the system can determine if “Tap-to-Talk-With-Silence-Detection”functionality is suitable. If so, the system may present a “Tap-to-Talk-With-Silence-Detection” icon at step 1309, and perform a “Tap-to-Talk-With-Silence-Detection” operation at step 1310. The “Tap-to-Talk-With-Silence-Detection” icon may appear as a modification of, or icon in proximity to, speech interface 303. In some embodiments, no icon is present (e.g., step 1309 is skipped) and the system performs “Tap-to-Talk-With-Silence-Detection” operation at step 1310 using the existing icon(s). The “Tap-to-Talk-With-Silence-Detection” operation may include a process whereby recording at the user device's microphone is disabled when the characters initially wait for a response from the user. Upon selecting an icon, such as speech interface 303, recording at the user device's microphone may be enabled and the user may respond to the conversation involving the synthetic characters. Following completion of their response, the user may fall silent, without actively disabling the microphone. The system may detect the subsequent silence and stop the recording after some threshold period of time has passed. In some embodiments, silence may be detected by measuring the energy of the recording's frequency spectrum.

If the system does not determine that any of “Hold-to-Talk”, “Tap-to-Talk”, or “Tap-to-Talk-With-Silence-Detection” is suitable, the system may perform an “Automatic-Voice-Activity-Detection” operation. During “Automatic-Voice-Activity-Detection” the system may activate a microphone 1311, if not already activated, on the user device. The system may then analyze the power and frequency of the recorded audio to determine if speech is present at step 1312. If speech is not present over some threshold period of time, the system may conclude the recording.

### Social Asset Messaging

FIG. 14 illustrates an example screenshot of a social asset sharing GUI as may be implemented in certain embodiments. In these embodiments, a reviewer, such as the user or a relation of the user, may be presented with a series of images 1401 captured during various interactions with the synthetic characters. For example, some of the images may have been voluntarily requested by the user and may depict various asset overlays to the user's image, such as hat and/or facial hair. In some embodiments, the plurality of images 1401 may also include images automatically taken of the user at various moments in various interactions. Gallery controls 1402 and 1403 may be used to select from different collections of images, possibly images organized by different scenarios engaged with the user.

FIG. 15 illustrates an example screenshot 1500 of a message drafting tool in the social asset sharing GUI of FIG. 14 as may be implemented in certain embodiments. Following selection of an image to share, the system may present a pop-up display 1501. The display 1501 may include an enlarged version 1502 of the selected image and a region 1503 for accepting text input. An input 1505 for selecting one or more message mediums, such as Facebook, MySpace, Twitter, etc. may also be provided. The user may insert commentary text in the region 1503. By selecting sharing icon 1504, the user may share the image and commentary text with a community specified by input 1505. In some embodiments the message drafting tool is used by a parent of the child user.

FIG. 16 is a flowchart depicting certain steps in a social image capture process as may be implemented in certain embodiments. At step 1601, the system may determine that image capture is relevant to a conversation. For example, following initiation of a roleplaying sequence which involves overlaying certain assets on the user's image 304b (or at image 401, 501, etc.) the system may be keyed to encourage the user to have their image, with the asset overlaid, captured. Following the overlaying of the asset on to the user image at step 1602 the system may propose that the user engage in an image capture at step 1603. The proposal may be made by one of the synthetic characters in the virtual environment. If the user agrees, possibly via an oral response, at step 1604, the system may capture an image of the user at step 1605. The system may then store the image at step 1606 and present the captured image for review at step 1607. The image may be presented for review by the user, or by another individual, such as the user's mother or other family member. If the image is accepted for sharing during the review at step 1608 the system may transmit the captured image for sharing at step 1609 to a selected social network.

### Computer System Overview

Various embodiments include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 17 is an example of a computer system 1700 with which various embodiments may be utilize. Various of the disclosed features may be located on computer system 1700. According to the present example, the computer system includes a bus 1705, at least one processor 1710, at least one communication port 1715, a main memory 1720, a removable storage media 1725, a read only memory 1730, and a mass storage 1735.

Processor(s) 1710 can be any known processor, such as, but not limited to, an Intel® Itanium® or Itanium 2® processor(s), or AMD® Opteron® or Athlon MP® processor(s), or Motorola® lines of processors. Communication port(s) 1715 can be any of an RS-232 port for use with a modem based dialup connection, a 10/100 Ethernet port, or a Gigabit port using copper or fiber. Communication port(s) 1715 may be chosen depending on a network such a Local Area Network (LAN), Wide Area Network (WAN), or any network to which the computer system 1700 connects.

Main memory 1720 can be Random Access Memory (RAM), or any other dynamic storage device(s) commonly known in the art. Read only memory 1730 can be any static storage device(s) such as Programmable Read Only Memory (PROM) chips for storing static information such as instructions for processor 1710.

Mass storage 1735 can be used to store information and instructions. For example, hard disks such as the Adaptec® family of SCSI drives, an optical disc, an array of disks such as RAID, such as the Adaptec family of RAID drives, or any other mass storage devices may be used.

Bus 1705 communicatively couples processor(s) 1710 with the other memory, storage and communication blocks. Bus 1705 can be a PCI/PCI-X or SCSI based system bus depending on the storage devices used.

Removable storage media 1725 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations. Therefore, the above description should not be taken as limiting the scope of the invention.

### Remarks

While the computer-readable medium is shown in an embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding or carrying a set of instructions for execution by the computer and that cause the computer to perform any one or more of the methodologies of the presently disclosed technique and innovation.

The computer may be, but is not limited to, a server computer, a client computer, a personal computer (PC), a tablet PC, a laptop computer, a set-top box (STB), a personal digital assistant (PDA), a cellular telephone, an iPhone®, an iPad®, a processor, a telephone, a web appliance, a network router, switch or bridge, or any machine capable of executing a set of instructions (sequential or otherwise) that specify actions to be taken by that machine.

In general, the routines executed to implement the embodiments of the disclosure, may be implemented as part of an operating system or a specific application, component, program, object, module or sequence of instructions referred to as “programs,” The programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, various embodiments are capable of being distributed as a program product in a variety of forms, and that the disclosure applies equally regardless of the particular type of computer-readable medium used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for the disclosure, are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teaching of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limited the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method for engaging a user in conversation with a synthetic character, the method comprising:
receiving an audio input from a user, the audio input comprising speech;
acquiring a textual description of the speech;
determining a responsive audio output based upon the textual description; and
causing a synthetic character to speak using the determined responsive audio output.

2. The method of claim 1, further comprising:
receiving a plurality of audio inputs comprising speech from a user, the plurality of audio inputs associated with a plurality of spoken outputs from one or more synthetic characters.

3. The method of claim 2, wherein the plurality of audio inputs comprise answers to questions posed by one or more synthetic characters.

4. The method of claim 2, wherein the plurality of audio inputs comprise a narration of text and the plurality of spoken outputs from one or more synthetic characters comprise ad-libbing or commentary to the narration.

5. The method of claim 2, wherein the plurality of audio inputs comprise statements in a dialogue regarding a topic.

6. The method of claim 1, wherein acquiring a textual description of the speech comprises transmitting the audio input to a dedicated speech processing service.

7. The method of claim 1, wherein receiving an audio input comprises determining whether to perform one of “Automatic-Voice-Activity-Detection”, “Hold-to-Talk”, “Tap-to-Talk”, or “Tap-to-Talk-With-Silence-Detection” operations.

8. The method of claim 7, further comprising modifying an icon to reflect the determined audio input operation.

9. The method of claim 1, wherein determining a responsive audio output comprises determining user personalization metadata.

10. The method of claim 1, the method further comprising acquiring phoneme metadata associated with the responsive audio output for the purpose of animating some of the character's facial features.

11. The method of claim 1, further comprising reviewing a plurality of responses from the user and performing more inter-character dialogue rather than user-character dialogue based on the review.

12. The method of claim 1, further comprising associating prioritization metadata with each potential response for the synthetic character and using these prioritization metadata to cause one possible response to be output before other responses.

13. The method of claim 1, wherein causing a synthetic character to speak using the determined responsive audio output comprises causing the synthetic character to propose taking a picture using a user device.

14. The method of claim 1, further comprising:
causing a picture to be taken of a user, using a user device; and
sending the picture to one or more users of a social network.

15. A method for visually engaging a user in conversation with a synthetic character comprising:
retrieving a plurality of components associated with an interactive scene, the interactive scene selected by a user;
configuring at least one of the plurality of components to represent a synthetic character in the scene; and
transmitting at least some of the plurality of components to a user device.

16. The method of claim 15, further comprising retrieving personalization metadata associated with a user and modifying at least one of the plurality of components based on the personalization metadata.

17. The method of claim 15, wherein retrieving a plurality of components comprises retrieving a plurality of speech waveforms from a database.

18. A computer system for engaging a user in conversation with a synthetic character, the system comprising:
a display;
a processor;
a communication port;
a memory containing instructions, wherein the instructions are configured to cause the processor to:
receive an audio input from a user, the audio input comprising speech;
acquire a textual description of the speech;
determine a responsive audio output based upon the textual description; and
cause a synthetic character to speak using the determined responsive audio output.

19. The computer system of claim 18, wherein receiving an audio input comprises determining whether to perform one of “Automatic-Voice-Activity-Detection”, “Hold-to-Talk”, “Tap-to-Talk”, or “Tap-to-Talk-With-Silence-Detection” operations.

20. The computer system of claim 19, the instructions further configured to cause the processor to modify an icon to reflect the determined operation.

21. The computer system of claim 18, wherein to determine a responsive audio output comprises determining user personalization metadata.

22. The computer system of claim 18, the instructions further configured to cause the processor to acquire phoneme metadata associated with the responsive audio output for the purpose of animating some of the character's facial features.

23. The computer system of claim 18, the instructions further configured to cause the processor to review a plurality of responses from the user and perform more inter-character dialogue rather than user-character dialogue based on the review.

24. The computer system of claim 18, instructions further configured to cause the processor to associate prioritization metadata with each potential response for the synthetic character and use these prioritization metadata to cause one possible response to be output before other responses.

25. The computer system of claim 18, wherein causing a synthetic character to speak using the determined responsive audio output comprises causing the synthetic character to propose taking a picture using a user device.

26. A computer system for engaging a user in conversation with a synthetic character, the computer system comprising:
means for receiving an audio input from a user, the audio input comprising speech;
means for determining a description of the speech;
means for determining a responsive audio output based upon the description; and
means for causing a synthetic character to speak using the determined responsive audio output.

27. The computer system of claim 26, wherein the audio input receiving means comprises one of a microphone, a packet reception module, a WiFi receiver, a cellular network receiver, an Ethernet connection, a radio receiver, a local area connection, or an interface to a transportable memory storage device

28. The computer system of claim 26, wherein the speech description determining means comprises one of a connection to a dedicated speech processing server, a natural language processing program, a speech recognition system, a Hidden Markov Model, or a Bayesian Classifier.

29. The computer system of claim 26, wherein the responsive audio output determination means comprises one of an Artificial Intelligence engine, a Machine Learning classifier, a decision tree, a state transition diagram, a Markov Model, or a Bayesian Classifier.

30. The computer system of claim 26, wherein the synthetic character speech means comprises one of a speaker, a connection to a speaker on a mobile device, a WiFi transmitter in communication with a user device, a packet transmission module, a cellular network transmitter in communication with a user device, an Ethernet connection in communication with a user device, a radio transmitter in communication with a user device, or a local area connection in communication with a user device.
